(19) United States
(12) Patent Application Publication
(10) Pub. No.: US 2025/0300178 A1
(43) Pub. Date: Sep. 25, 2025

(54) HARD CARBON NEGATIVE ELECTRODE MATERIAL, NEGATIVE ELECTRODE PLATE AND BATTERY

(71) Applicant: ZHUHAI COSMX BATTERY CO., LTD., Zhuhai (CN)

(72) Inventors: Xiaohang LI, Zhuhai (CN); Chunyang LIU, Zhuhai (CN); Suli LI, Zhuhai (CN)

(73) Assignee: ZHUHAI COSMX BATTERY CO., LTD., Zhuhai (CN)

(21) Appl. No.: 19/230,527

(22) Filed: Jun. 6, 2025

Related U.S. Application Data
(63) Continuation-in-part of application No. PCT/CN2024/075150, filed on Feb. 1, 2024.

(30) Foreign Application Priority Data
Feb. 6, 2023 (CN) 202310068590.0
Feb. 6, 2023 (CN) 202310068906.6

(51) Int. Cl. H01M 4/587; C01B 32/05; H01M 10/0525; H01M 10/054

(52) U.S. Cl. CPC H01M 4/587; C01B 32/05; H01M 10/0525; H01M 10/054; C01P 2002/78; C01P 2002/88; C01P 2004/61; C01P 2006/11; C01P 2006/12; C01P 2006/16; C01P 2006/40

(57) ABSTRACT

A hard carbon negative electrode material includes a microstructure of multi-microporous layers. A most probable pore size of the micropores is 0.35 nm-1.5 nm, and a conductivity of the hard carbon negative electrode material under 63.66 Mpa is 0.3-130 S/cm. This hard carbon negative electrode material has a special ultrafine micropore structure. When applied to lithium-ion batteries, it can achieve micropore lithium insertion, allowing lithium ions to transform into clustered lithium within the microporous structure of the hard carbon negative electrode material near 0V voltage. This effectively prevents the growth of lithium dendrites while also effectively controlling the volume expansion of the negative electrode material before and after lithium insertion, thereby reducing the voltage between the positive and negative electrodes and improving high-temperature cycling.

### CROSS-REFERENCE TO RELATED APPLICATIONS

The present application is a continuation-in-part of International Application No. PCT/CN2024/075150, filed on Feb. 1, 2024, which claims priority to Chinese Patent Application No. 202310068906.6, filed on Feb. 6, 2023, and Chinese Patent Application No. 202310068590.0, filed on Feb. 6, 2023. All of the aforementioned applications are incorporated herein by reference in their entireties.

### TECHNICAL FIELD

This disclosure relates to the technical field of negative electrode materials, specifically to a hard carbon negative electrode material, negative electrode plate, and battery.

### BACKGROUND

Non-aqueous electrolyte secondary batteries mainly consist of four components: positive electrode material, negative electrode material, non-aqueous electrolyte, and separator. The positive electrode materials generally use transition metal oxides, while the negative electrode typically employs graphite-based carbon materials. Conventional graphite negative electrode carbon materials exhibit problems such as excessive volume expansion and rapid decline in cycle capacity retention after several hundred cycles in secondary batteries. In the doctoral thesis of Dr. Zhang Jie, it is suggested that the overvoltage of positive electrode materials in secondary batteries can lead to the dissolution of transition metal elements, and the dissolved transition metal ions further catalyze the growth of the Solid Electrolyte Interphase (SEI) film on the negative electrode, resulting in increased polarization of the cell and cycle failure of the cell. The research and use of high-voltage resistant positive electrode materials are key factors in improving the cycling performance of secondary batteries. Lin Cong's article published in the Nature Nanotechnology journal indicates that conventional lithium cobalt oxide positive electrode materials begin to undergo irreversible structural damage at around 4.5 V. Current doping and coating technologies can moderately increase the working voltage of positive electrode materials, but it is difficult to break through 4.6 V.

From the perspective of the negative electrode in secondary batteries, under a fixed voltage difference of the full battery, a lower negative electrode working platform voltage can also achieve the goal of reducing the working voltage of the positive electrode. Therefore, developing negative electrode materials with a lower working platform voltage is expected to improve the cycle life of secondary batteries. It is known that the lithium-ion intercalation platform voltage of conventional graphite negative electrode carbon materials is close to the lithium metal reduction voltage of 0 V, so lowering the lithium intercalation voltage of the negative electrode may cause some lithium ions to be reduced to lithium metal, resulting in lithium plating issues. The lithium plating issue can lead to the growth of lithium dendrites, which in turn poses a risk of separator puncture and short-circuiting of the battery cell.

Therefore, it is very important to develop a negative electrode material that can avoid lithium dendrite growth and reduce the voltage of the positive and negative electrodes.

### SUMMARY

The purpose of this disclosure is to overcome the above-mentioned problems present in the conventional technology and to provide a hard carbon negative electrode material, a negative electrode plate containing the hard carbon negative electrode material, and a battery. The hard carbon negative electrode material provided by this disclosure can effectively avoid the growth of lithium dendrites in lithium-ion batteries containing this hard carbon negative electrode material, achieving the goal of reducing the voltage of the positive and negative electrodes.

Research has found that the hard carbon negative electrode material has a special ultrafine microporous structure, and when applied to lithium-ion batteries, it can achieve lithium intercalation in the micropores, allowing lithium ions to transform into clustered lithium near 0V voltage within the microporous structure of the hard carbon negative electrode material. This effectively avoids the growth of lithium dendrites while effectively controlling the volumetric expansion of the negative electrode material before and after lithium intercalation, thus achieving the goal of reducing the voltage of the positive and negative electrodes. Moreover, while improving the cycle capacity retention rate of battery, it can also reduce the volume expansion rate of the negative electrode.

Research has also found that the hard carbon negative electrode material, when applied to sodium-ion batteries, can achieve microporous sodium intercalation, which can reduce the phenomenon of sodium precipitation on the negative electrode, thereby effectively avoiding the growth of sodium dendrites (similar to the improvement mechanism in lithium batteries).

To achieve the above objectives, a first aspect of this disclosure provides a hard carbon negative electrode material, including a microstructure of multi-microporous layers; where a most probable pore size of micropores is 0.35 nm-1.5 nm, and a conductivity of the hard carbon negative electrode material under 63.66 Mpa is 0.3-130 S/cm.

A second aspect of this disclosure provides a negative electrode plate, including the hard carbon negative electrode material described in the first aspect of this disclosure, and may also include other negative electrode active materials.

A third aspect of this disclosure provides a battery, including the hard carbon negative electrode material described in the first aspect of this disclosure, or the negative electrode plate described in the second aspect of this disclosure.

The disclosure of the above technical solution has the following beneficial effects.

The hard carbon negative electrode material provided in this disclosure has an ultrafine microporous structure. When applied to lithium batteries, this microporous structure serves as a container for lithium intercalation, allowing lithium ions to transform into clustered lithium states near 0 V voltage within the micropores of the hard carbon negative electrode material, thereby avoiding lithium dendrite growth and enhancing the safety performance of lithium batteries.

The hard carbon negative electrode material provided in this disclosure also has an ultrafine microporous structure. When applied to sodium-ion batteries, it can facilitate sodium intercalation within the micropores, which can reduce sodium plating phenomena, effectively avoiding sodium dendrite growth and improving the safety performance of sodium batteries.

The hard carbon negative electrode material disclosed can reduce the working potential of the negative electrode, thereby lowering the working voltage of the positive electrode, reducing the leaching of transition metal elements caused by overvoltage at the positive electrode, and significantly improving the cycle performance of the battery.

The endpoints and any values within the scope disclosed in this document are not limited to that precise range or value; these ranges or values should be understood to include values close to those ranges or values. For numerical ranges, the endpoints between various ranges, the endpoints and individual point values between different ranges, as well as between individual point values can be combined to obtain one or more new numerical ranges, which should be considered specifically disclosed in this document.

### BRIEF DESCRIPTION OF THE DRAWINGS

FIG. 1 shows the dt/dwt %-t curve of the thermogravimetric analysis test for hard carbon negative electrode materials in Example 1.

FIG. 2 shows the charge and discharge curve changes of the battery in Example 1 at 45° C. with a 3 C rate.

FIG. 3 shows the curve changes of the cycle capacity retention rate of the battery in Example 1 at 45° C. with a 3 C rate.

### DETAILED DESCRIPTIONS OF THE EMBODIMENTS

The following provides a detailed description of the specific implementation of this disclosure. It should be understood that the specific implementations described here are intended for illustration and explanation of this disclosure, and do not serve to limit this disclosure.

Unless otherwise defined, all scientific and technical terms used in this disclosure have the same meanings as understood by those skilled in the relevant technical field.

A first aspect of this disclosure provides a hard carbon negative electrode material, including a microstructure of multi-microporous layers; where a most probable pore size of micropores is 0.35 nm-1.5 nm; and a conductivity of the hard carbon negative electrode material is 0.3-130 S/cm at 63.66 Mpa.

In some implementations, the hard carbon negative electrode material has a microstructure of multi-microporous layers; where a most probable pore size of the micropores is 0.35 nm-1.5 nm, and a conductivity of the hard carbon negative electrode material is 2-130 S/cm at 63.66 Mpa.

In this disclosure, the microporous pore size distribution curve of the hard carbon negative electrode material exhibits a peak; the corresponding pore size at this peak is referred to as the “most probable pore size”, which indicates that pores within this size range have the highest occurrence probability.

In this disclosure, a precise instrument is required to measure the “most probable pore size”. The precise instrument needs to have a dual-stage vacuum system, multi-stage pressure sensors in the 10⁻³ Pa range, and a precise control system for low-pressure. This ensures the measurement of the most probable pore size can range from 0.35 nm to 2 nm.

In some embodiments, the most probable pore size of the micropores may be, for example, 0.35 nm, 0.5 nm, 0.6 nm, 0.7 nm, 0.8 nm, 0.9 nm, 0.93 nm, 1 nm, 1.2 nm, 1.4 nm, or 1.5 nm.

In some embodiments, the electrical conductivity testing method for the hard carbon negative electrode material at 63.66 MPa is the four-probe powder testing method. Specifically, under applied pressure, the resistance value and thickness of the powder sample in a fixed area is tested utilizing a high-precision four-probe instrument, and a testing software automatically calculates its physical quantities, such as resistivity, conductivity, and compacted density.

In some embodiments, the conductivity of the hard carbon negative electrode material at 63.66 MPa can be, for example, 0.3 S/cm, 2 S/cm, 5 S/cm, 10 S/cm, 20 S/cm, 30 S/cm, 40 S/cm, 50 S/cm, 60 S/cm, 70 S/cm, 80 S/cm, 90 S/cm, 100 S/cm, 120 S/cm, or 130 S/cm.

In this disclosure, taking the application of the hard carbon negative electrode material in lithium-ion batteries as an example, by limiting the most probable pore size of the micropores in the hard carbon material, the ultrafine micropores in the hard carbon negative electrode material can serve as containers for lithium intercalation, allowing lithium ions to be reduced to lithium metal and adsorbed within the ultrafine micropores near 0V potential, thus avoiding lithium dendrite growth while lowering the working potential of the negative electrode, further reducing the working voltage of the positive electrode, and decreasing the leaching of transition metal elements caused by excessive positive electrode voltage, significantly improving the cycling performance of the battery.

Further research has found that when hard carbon powder has a most probable pore size of micropores between 0.35 nm and 1.5 nm and simultaneously meet a conductivity of 2-130 S/cm at 63.66 MPa, the combined effect of micropore size and conductivity can enhance the lithium intercalation performance of the hard carbon negative electrode, better avoiding the lithium plating issue in lithium batteries. At the same time, the sodium intercalation performance is also very good, which can similarly avoid the sodium plating issue in sodium batteries.

To further improve the effects of avoiding lithium plating problems and preventing lithium dendrite growth, as well as reducing the voltage of the negative electrode and positive electrode, further optimization can be performed on one or more technical features of the aforementioned scheme.

Preferably, the most probable pore size of the micropores is 0.4 nm-1.2 nm, more preferably 0.5 nm-0.9 nm.

Preferably, the conductivity of the hard carbon negative electrode material is 5-80 S/cm at 63.66 Mpa.

In some embodiments, a temperature range corresponding to a complete removal of water from the micropores of the hard carbon negative electrode material is 150-450° C., for example, it can be 150° C., 200° C., 250° C., 300° C., 320° C., 340° C., 350° C., 380° C., 400° C., 450° C.

In this disclosure, due to the microporous structure of the hard carbon negative electrode material, it is difficult for the physically adsorbed water molecules to escape at the boiling point temperature of water, thereby affecting the performance of the hard carbon material. The hard carbon material can completely remove water molecules within the temperature range of 150-450° C. When the dehydration temperature is lower than 150° C., it cannot effectively avoid the growth of lithium dendrites generated during low voltage lithium intercalation around 0 V, thereby reducing the battery's capacity retention rate and increasing the cycling expansion rate. When the dehydration temperature is higher than 450° C., it is not possible to remove the moisture within the micropores of the hard carbon material through conventional processing methods. Additionally, excessive moisture will occupy the lithium intercalation potential, inducing the generation of HF in the electrolyte solution, which deteriorates the performance of the battery. This temperature range is closely related to the most probable pore size range of ultrafine micropores in hard carbon negative electrode materials. The larger the temperature range, the wider the most probable pore size range of the micropores; conversely, the smaller the temperature range, the narrower the most probable pore size range, resulting in a more uniform pore size distribution. Therefore, when the hard carbon negative electrode material is within the aforementioned temperature range, it exhibits good lithium/sodium intercalation performance, effectively preventing lithium dendrite growth, improving the cycle retention rate of lithium batteries, and reducing the cycling expansion rate.

In some embodiments, thermogravimetric analysis is used for testing, where the temperature corresponding to the lowest point on the dt/dwt %-t curve is denoted as Tmin (dt/dwt %-t), which is the temperature at which all moisture molecules adsorbed in the micropores of the hard carbon negative electrode material are expelled.

Preferably, the temperature range corresponding to the complete removal of water from the micropores of the hard carbon negative electrode material is 160-400° C., with a most preferred range of 200-380° C. The most probable pore size range for the corresponding micropores is 0.4 nm-1.2 nm, with a most preferred range of 0.5 nm-0.9 nm. The most probable pore size range and dehydration temperature of the hard carbon negative electrode material make the pore size distribution of the micropores more uniform, better serve the purpose of lithium/sodium intercalation in the micropores, and more effectively prevent lithium dendrite growth.

In some embodiments, an average interlayer spacing d₀₀₂ of layered structure is 0.3 nm-0.45 nm.

In some embodiments, the average interlayer spacing d₀₀₂ of the layered structure is the average interlayer spacing of the (002) crystal plane obtained using X-ray diffraction.

In some embodiments, the average interlayer spacing d₀₀₂ of the layered structure can be, for example, 0.3 nm, 0.35 nm, 0.355 nm, 0.36 nm, 0.37 nm, or 0.45 nm.

Preferably, the average interlayer spacing d₀₀₂ of the layered structure is 0.35 nm-0.42 nm. The hard carbon negative electrode material having the d₀₀₂ within this range has a larger interlayer spacing, which is conducive to the rapid insertion and extraction of sodium ions or lithium ions, ensuring better capacity retention and cycle performance of the battery during high-rate charge and discharge processes.

In some embodiments, a Dv50 of the hard carbon negative electrode material is 0.3 μm-35 μm, with a maximum particle size Dv100 not exceeding 100 μm.

Preferably, the Dv50 of the hard carbon negative electrode material is 3 m-30 μm, with a maximum particle size Dv100 not exceeding 90 μm. Dv50 can be tested using a laser particle size analyzer. Dv50 refers to the particle size corresponding to the cumulative volume particle size distribution percentage reaching 50% for a sample. Dv100 refers to the maximum value of the volume particle size of a sample.

When the Dv50 and maximum particle size Dv100 of the hard carbon negative electrode material are within the above range, it results in a narrower particle size distribution, avoiding excessively large or small particle sizes, thereby improving the lithium or sodium embedding effect of the hard carbon negative electrode material and further enhancing its first efficiency and charge-discharge capacity.

In some embodiments, a specific surface area of the hard carbon negative electrode material is 0.5 m²/g to 80 m²/g, for example, it can be 0.5 m²/g, 1 m²/g, 2 m²/g, 5 m²/g, 10 m²/g, 20 m²/g, 40 m²/g, 60 m²/g, 70 m²/g, or 80 m²/g.

Preferably, the specific surface area of the hard carbon negative electrode material is 0.8 m²/g to 30 m²/g, more preferably 1 m²/g to 25 m²/g.

In some embodiments, a tap density of the hard carbon negative electrode material is 0.2 g/cm³ to 1.11 g/cm³, for example, it can be 0.2 g/cm³, 0.4 g/cm³, 0.5 g/cm³, 0.7 g/cm³, 0.9 g/cm³, or 1.1 g/cm³. Preferably, the tap density of the hard carbon negative electrode material is 0.3 g/cm³ to 1.0 g/cm³.

When the specific surface area and tap density of the hard carbon negative electrode material fall within the aforementioned ranges, on one hand, it allows the hard carbon negative electrode material to better perform the role of a container for lithium/sodium intercalation; on the other hand, a reasonable range of tap density and specific surface area facilitates the blending of the hard carbon negative electrode material during the cell manufacturing process and the processing of the coating step.

In some embodiments, a delithiation/desodiation capacity of the hard carbon negative electrode material at 0.8 V is denoted as A, and a delithiation/desodiation capacity at 2 V is denoted as B, with a ratio of A/B being 0.2 to 0.99, preferably 0.2 to 0.9.

In this disclosure, the term “delithiation/desodiation capacity” refers to the delithiation capacity or de-sodium capacity.

It should be noted that the “delithiation/desodiation capacity at 0.8 V” and “delithiation/desodiation capacity at 2 V” refer to the values obtained from tests conducted with electrodes made of hard carbon negative electrode materials in button-type half-cells containing lithium/sodium strips, with a testing protocol being: discharging at 0.01 mA constant current to a lower limit voltage V₁, resting for 10 minutes, and then charging at 0.3 mA constant current to 2 V. Here, the statement “discharging at 0.01 mA constant current to a lower limit voltage” refers to the lithium/sodium intercalation process of the button-type half-cell, and its discharge capacity is defined as the lithium/sodium intercalation capacity. The statement “charging at 0.3 mA constant current to 2 V” refers to the delithiation/desodiation process of the button-type half-cell, and its charging capacity is defined as the delithiation/desodiation capacity. Where the range for the lower limit voltage V1 is −100 mV to 100 mV.

It should be noted that the “delithiation/desodiation capacity at 0.8 V” refers to the delithiation/desodiation capacity of the hard carbon negative electrode material during the constant current charging stage of the coin-type half-cell as the voltage rises to 0.8 V, denoted as A. The ‘delithiation/desodiation capacity at 2 V’ refers to the delithiation/desodiation capacity of the hard carbon negative electrode material at the moment the voltage rises to 2 V during the constant current charging stage of the coin-type half-cell, denoted as B.

In some embodiments, the ratio of A/B can be 0.2, 0.23, 0.3, 0.36, 0.4, 0.48, 0.5, 0.53, 0.6, 0.62, 0.7, 0.74, 0.8, 0.88, 0.9, or 0.99.

Preferably, the ratio of A/B is between 0.3 and 0.88.

When the ratio of delithiation/desodiation capacity of the hard carbon negative electrode material at 0.8 V and 2 V falls within the above range, it can correspond to the micropore size parameters of the hard carbon material, thereby achieving the objective of improving the capacity retention rate and expansion rate of the battery.

In some embodiments, in a three-electrode full battery made with the hard carbon negative electrode, a positive electrode, and a lithium-coated copper wire reference electrode, the potential difference between the lithium-coated copper wire reference electrode and the hard carbon negative electrode is the voltage E. The ratio of lithium/sodium intercalation capacity at 50 mV to the total lithium/sodium intercalation capacity is α.

In this disclosure, the term “lithium/sodium intercalation capacity” refers to either lithium intercalation capacity or sodium intercalation capacity.

In some embodiments, during the evaluation of the three-electrode full battery, when charged at a rate of 0.2 C-3 C, the ratio α of the lithium/sodium intercalation capacity at 50 mV to the total lithium/sodium intercalation capacity of the hard carbon negative electrode material is 12%-85%.

It should be noted that the fabrication of the three-electrode battery employs a common industry technology for in-situ lithium plating of the copper wire reference electrode, where the copper wire can be inserted either early during the production of dry cells or later after the battery has been formed at the factory. The “lithium/sodium intercalation capacity at 50 mV” and the “total lithium/sodium intercalation capacity” occur during the process of charging the battery at a specific rate to the upper voltage limit under constant current. “Specific rate of charge” refers to charge rates of 0.2 C, 1 C, 2 C, and 3 C. It should be noted that the “lithium/sodium intercalation capacity at 50 mV” refers to the lithium/sodium intercalation capacity of the hard carbon negative electrode material when the voltage E drops to 50 mV during the constant current charging stage of a three-electrode full battery. The “total lithium/sodium intercalation capacity” refers to the total charging capacity of the three-electrode battery when the potential difference between the positive and negative electrodes rises to the upper voltage limit (4 V or 4.45 V) during the constant current charging stage.

In some embodiments, at a charging rate of 0.2 C, a ratio α1 of the lithium/sodium intercalation capacity at 50 mV to the total lithium/sodium intercalation capacity of the hard carbon negative electrode material ranges from 5% to 45%, for example, it can be 5%, 10%, 20%, 30%, 40%, or 45%, preferably from 10% to 45%, more preferably from 10% to 38%, and further preferably from 20% to 38%.

In some implementations, when charging at a 1 C rate, a ratio α2 of the lithium/sodium intercalation capacity at 50 mV to the total lithium/sodium intercalation capacity of the hard carbon negative electrode material is 25%-60%, for example, it can be 25%, 30%, 35%, 40%, 50%, 55%, or 60%, preferably 30%-55%.

In some implementations, when charging at a 2 C rate, a ratio α3 of the lithium/sodium intercalation capacity at 50 mV to the total lithium/sodium intercalation capacity of the hard carbon negative electrode material is 35%-75%, for example, it can be 35%, 40%, 45%, 50%, 60%, 70%, or 75%, preferably 40%-62%.

In some implementations, when charging at a 3 C rate, a ratio α4 of the lithium/sodium intercalation capacity at 50 mV to the total lithium/sodium intercalation capacity of the hard carbon negative electrode material is 38%-85%, for example, it can be 38%, 40%, 45%, 50%, 60%, 70%, 75%, 80%, or 85%, preferably 42%-78%.

When the lithium/sodium intercalation capacity ratios of the hard carbon negative electrode material are within the above ranges at different charging rates, it can further improve the capacity retention rate and expansion rate of the battery.

A precursor for preparing the hard carbon negative electrode material in this disclosure includes a resin precursor, an organic polymer pyrolytic carbon precursor, a carbon black precursor, a biomass carbon precursor, or other precursors.

In some embodiments, the resin precursor includes one or more of phenolic resin, epoxy resin, furfuryl alcohol resin, furfural resin, and furan resin; the organic polymer pyrolytic carbon precursor includes one or more of naphthalene, anthracene, phenanthrene, benzene carbon, furfuryl alcohol pyrolytic carbon, polyvinyl chloride pyrolytic carbon, phenolic pyrolytic carbon, tetrafluoroethylene-perfluoroalkyl vinyl ether, polyvinylidene fluoride, polyacrylonitrile, and polyvinyl pyrrolidone; the carbon black precursor includes one or more of acetylene black, carbon black, and superconductive carbon black; the biomass carbon precursor includes plant components such as fruit shells, straw, etc., sugars such as starch, sucrose, glucose, maltose, and amino acids such as glycine, alanine, etc. The preparation method of the hard carbon negative electrode material is consistent with all currently disclosed methods for preparing hard carbon.

The second aspect of this disclosure provides a negative electrode plate, including the hard carbon negative electrode material described in the first aspect of this disclosure, and may also include other negative electrode active materials.

The negative electrode plate provided in the second aspect of this disclosure has all the advantages of the hard carbon negative electrode material, which will not be repeated here.

Other negative electrode active materials may include artificial graphite, natural graphite, soft carbon, and other commonly used negative electrode materials.

The negative electrode plates described in this disclosure can be applied to lithium-ion batteries and can also be applied to sodium-ion batteries, with specific application scenarios being freely selectable.

The third aspect of this disclosure provides a battery, including the hard carbon negative electrode material described in the first aspect of this disclosure, or the negative electrode plate described in the second aspect of this disclosure.

In some embodiments, the battery disclosed herein is a secondary battery, which includes a positive electrode, a negative electrode, a separator, and a non-aqueous electrolyte. The battery is also referred to as a non-aqueous electrolyte secondary battery.

In some embodiments, the secondary battery is a lithium-ion secondary battery.

In some embodiments, the secondary battery is a sodium-ion secondary battery.

There are no specific limitations on the positive electrode, separator, and non-aqueous electrolyte of the battery; they can be selected from materials or systems commonly used in the field according to the type of battery and application scenario.

In some embodiments, when the battery is a lithium-ion battery, a discharge capacity during a voltage drop from 4.45 V to 3 V is denoted as C_{Li}, and a discharge capacity during a voltage drop from 4.45 V to 2.5 V is denoted as D_{Li}, with a ratio of C_{Li}/D_{Li} ranging from 0.3 to 0.9, for example, 0.3, 0.4, 0.5, 0.6, 0.7, 0.8, or 0.9. When the hard carbon negative electrode material is the same, the different positive electrode material systems of the battery can also affect the ratio of C_{Li}/D_{Li}.

In some embodiments, in the lithium ion secondary battery system where the hard carbon negative electrode material is paired with lithium cobalt oxide positive electrode material, the discharge capacity of the lithium ion battery during a voltage drop from 4.45 V to 3 V is denoted as C₁, and the discharge capacity during a voltage drop from 4.45 V to 2.5 V is denoted as D₁, with a ratio of C₁/D₁ ranging from 0.4 to 0.9, for example, 0.4, 0.5, 0.6, 0.7, 0.8, or 0.9.

In some embodiments, in the lithium ion secondary battery system where the hard carbon negative electrode material is paired with ternary positive electrode materials, a discharge capacity of this lithium ion battery during a voltage drop from 4.45 V to 3 V is denoted as C₂, and a discharge capacity during a voltage drop from 4.45 V to 2.5 V is denoted as D₂, with a ratio of C₂/D₂ ranging from 0.35 to 0.88, for example, 0.35, 0.4, 0.5, 0.6, 0.7, 0.8, or 0.88.

In lithium ion batteries, when the ratios of C₁/D₁ and C₂/D₂ are within the above ranges, it can indicate that the hard carbon negative electrode material has a high lithium intercalation capacity, which improves the discharge capacity of the lithium battery and enhances the capacity retention rate of the lithium battery.

In some embodiments, when the battery is a sodium battery, a discharge capacity during a voltage drop from 4 V to 3 V is denoted as C_{Na}, and a discharge capacity during a voltage drop from 4 V to 2 V is denoted as D_{Na}, with a ratio of C_{Na}/D_{Na} being 0.5-0.88, for example, 0.55, 0.6, 0.7, 0.8, or 0.88.

In some embodiments, in sodium ion secondary battery systems where the hard carbon negative electrode material is paired with layered oxides, poly-anionic compounds, and other industry-known sodium ion positive electrode materials, a discharge capacity of this sodium ion battery during a voltage drop from 4 V to 3 V is denoted as C₃, and a discharge capacity during a voltage drop from 4 V to 2 V is denoted as D₃, with a ratio of C₃/D₃ being 0.5-0.88, for example, 0.55, 0.6, 0.7, 0.8, or 0.88.

In sodium ion batteries, when the ratio C_{Na}/D_{Na} and the ratio C₃/D₃ are within the aforementioned range, it indicates that the hard carbon negative electrode material has a high sodium intercalation capacity, which enhances the discharge capacity of the sodium-ion battery and improves the capacity retention rate of the sodium-ion battery.

The non-aqueous electrolyte secondary batteries provided in this disclosure are mainly used in research and development for fast-charging digital batteries, high-power drone batteries, electric vehicle (EV) power batteries, hybrid electric vehicle (HEV) power batteries, and start-stop batteries, and so on.

The secondary battery (electrochemical device) disclosed here can take various forms well known to those skilled in the art.

In some embodiments, the electrochemical device includes, but is not limited to, soft packages, square aluminum shells, cylindrical types, and button batteries.

In some embodiments, the internal positive and negative electrodes of the electrochemical device can be combined by winding or stacking methods.

The following will provide a clear and complete description of the technical solutions in the disclosed embodiments, and it is evident that the described embodiments are only part of the disclosed embodiments, not all of them. Based on the embodiments in this disclosure, all other embodiments obtained by those skilled in the art without making creative efforts fall within the scope of protection of this disclosure.

The materials, reagents, etc., used in the following embodiments can be obtained commercially unless otherwise stated.

The following is a detailed description of the present disclosure in conjunction with specific implementation examples, which are used for understanding and not limiting the present disclosure.

### Example 1

A lithium-ion battery, which was prepared using the following method.

### (1) Preparation of a Negative Electrode Plate

Hard carbon negative electrode material (with the most probable pore size of 0.77 nm, Dv50 of 5.1 μm, specific surface area of 3.93 m²/g, d₀₀₂ of 0.376 nm, powder conductivity of 19.6 S/cm at 63.66 Mpa, Tmin(dt/dwt %-t)=348.16° C., and tap density of 0.81 g/cm³), carboxymethyl cellulose sodium (binder), styrene-butadiene rubber (binder), and Super P (conductive agent) was mixed in a mass ratio of 95:2:2:1, and deionized water was added to obtain the negative electrode slurry under the action of a vacuum mixer. The dt/dwt %-t curve of the hard carbon negative electrode material tested by thermogravimetric analysis method was shown in FIG. 1.

The negative electrode slurry was uniformly coated onto the surface of copper foil (negative current collector) with a thickness of 6 μm, with a coating areal density of 5.5 mg/cm². The copper foil coated with negative electrode slurry was transferred to a 90° C. oven for drying for 24 hours, after processes such as roll-pressing and cutting, the negative electrode plate was obtained.

### (2) Preparation of a Positive Electrode Plate

Lithium cobalt oxide (LCO), polyvinylidene fluoride (PVDF), acetylene black, and carbon nanotubes (CNTs) were mixed in a mass ratio of 96:2:1.5:0.5, N-methyl-2-pyrrolidone was added, and the mixture was stirred in a vacuum stirrer until a uniform positive electrode slurry was achieved. The positive electrode slurry was uniformly coated onto the surface of aluminum foil (positive current collector) with a thickness of 9 μm, with a coating areal density of 15.0 mg/cm². The coated aluminum foil was baked in an oven, then transferred to a 120° C. oven to dry for 8 hours, and then rolled and cut to obtain the positive electrode plate. The positive electrode plate was smaller in size than the negative electrode plate, and the reversible capacity per unit area of the positive electrode plate was about 4% lower than that of the negative electrode plate.

(3) The metal tabs of the positive and negative electrode plates were welded separately.

(4) A polyethylene separator with a thickness of 10 μm was selected.

(5) The prepared positive electrode plate, separator, and negative electrode plate were stacked in sequence, ensuring that the separator was placed between the positive and negative electrode plates to provide isolation, and then they were rolled to obtain a bare cell. The bare cell was placed in an aluminum-plastic film casing with a thickness of 0.090 mm, and after packaging, injecting the electrolyte solution, secondary packaging, resting, formation, shaping, sorting and other processes, the desired lithium-ion battery was obtained.

### Example 2

A lithium-ion battery, differing from Example 1, in that the hard carbon negative electrode material had a most probable pore size of 0.55 nm, Dv50 of 6.3 μm, specific surface area of 4.82 m²/g, d₀₀₂ of 0.364 nm, powder conductivity of 34.8 S/cm at 63.66 MPa, Tmin(dt/dwt %-t) of 375.22° C., and tap density of 0.79 g/cm³.

### Example 3

A lithium-ion battery, differing from Example 1, in that the hard carbon negative electrode material had a most probable pore size of 0.68 nm, Dv50 of 9.45 μm, specific surface area of 2.25 m²/g, d₀₀₂ of 0.359 nm, powder conductivity of 68.5 S/cm at 63.66 MPa, Tmin(dt/dwt %-t) of 278.49° C., and tap density of 0.66 g/cm³.

### Group of Examples 4

This group of Examples were used to illustrate the impact of changes in the most probable pore size, specific surface area and Tmin(dt/dwt %-t) of the hard carbon negative electrode material on battery performance.

Example 4a: differing from Example 1, in that the hard carbon negative electrode material had a most probable pore size of 1.12 nm, a specific surface area of 1.87 m²/g, and Tmin(dt/dwt %-t) of 170° C.

Example 4b: differing from Example 1, in that the hard carbon negative electrode material had a most probable pore size of 0.99 nm, a specific surface area of 1.95 m²/g, and Tmin(dt/dwt %-t) of 225° C.

### Group of Examples 5

This group of examples were used to illustrate the effect of the change in conductivity of hard carbon negative electrode materials at 63.66 Mpa on battery performance.

Example 5a: differing from Example 1, in that the hard carbon negative electrode material had a powder conductivity at 63.66 Mpa of 3 S/cm.

Example 5b: differing from Example 1, in that the hard carbon negative electrode material had a powder conductivity at 63.66 Mpa of 92 S/cm.

### Example 6

A lithium-ion battery, differing from Example 1, in that the ternary material of nickel cobalt manganese lithium with equal capacity replaced lithium cobalt oxide.

### Example 7

A sodium-ion battery, differing from Example 1, in that the positive electrode was Na₃V₂(PO₄)₂O₂F, the negative electrode current collector was aluminum foil, and the electrolyte solution was mainly composed of ethylene carbonate, propylene carbonate, and NaPF₆.

### Group of Examples 8

This group of examples were used to illustrate the effect of changes in the Dv50 of hard carbon negative electrode materials on battery performance.

Example 8a: differing from Example 1, in that the Dv50 of the hard carbon negative electrode material was 0.2 μm.

Example 8b: differing from Example 1, in that the Dv50 of the hard carbon negative electrode material was 38 μm.

### Example 9

A lithium-ion battery, differing from Example 1, in that the ratio of hard carbon material to artificial graphite material in the active material of the negative electrode plate was 2:8.

### Comparative Example 1

A lithium-ion battery, differing from Example 1, in that an equal amount of common hard carbon material was used as the negative electrode material. Its most probable pore size was 1.68 nm, with a powder conductivity of 130 S/cm at 63.66 Mpa, and Tmin(dt/dwt %-t) of 135° C.

### Comparative Example 2

A lithium-ion battery, differing from Example 1, in that the carbon negative electrode material had a most probable pore size of 2.1 nm, Dv50 of 13.55 μm, d₀₀₂ of 0.335 nm, and Tmin(dt/dwt %-t) of 120° C.

### Comparative Example 3

A lithium-ion battery, differing from Example 6, in that the carbon negative electrode material had a most probable pore size of 2.5 nm, Dv50 of 15.78 μm, d₀₀₂ of 0.331 nm, and Tmin(dt/dwt %-t) of 128° C.

### Comparative Example 4

A lithium-ion battery, differing from Example 1, in that the carbon negative electrode material had a most probable pore size of 0.3 nm, Dv50 of 5.5 μm, d₀₀₂ of 0.402 nm, and Tmin(dt/dwt %-t) of 480° C.

### Comparative Example 5

A sodium-ion battery, differing from Example 7, in that its negative electrode material was a common hard carbon material from comparative example 1.

### Comparative Example 6

A lithium-ion battery, differing from Example 1, in that an equal amount of common hard carbon material was used as the negative electrode material. Its most probable pore size was 1.58 nm, and the powder conductivity at 63.66 Mpa was 68 S/cm, with Tmin(dt/dwt %-t) of 142° C.

The batteries obtained from the above examples and the comparative examples were subjected to the following tests respectively.

### (1) Testing the Lithium/Sodium Intercalation Capacity Ratio and Discharge Capacity Ratio

(1.1) Testing the delithiation/desodiation capacity ratio A/B of the hard carbon negative electrode material at 0.8 V and 2 V.

It should be noted that the “delithiation/desodiation capacity at 0.8 V” and “delithiation/desodiation capacity at 2 V” refer to the values obtained from tests conducted with electrodes made of hard carbon negative electrode materials in button-type half-cells containing lithium/sodium strips, with a testing protocol being: discharging at 0.01 mA constant current to a lower limit voltage V₁, resting for 10 minutes, and then charging at 0.3 mA constant current to 2 V. Here, the statement “discharging at 0.01 mA constant current to a lower limit voltage” refers to the lithium/sodium intercalation process of the button-type half-cell, and its discharge capacity is defined as the lithium/sodium intercalation capacity. The statement “charging at 0.3 mA constant current to 2 V” refers to the delithiation/desodiation process of the button-type half-cell, and its charging capacity is defined as the delithiation/desodiation capacity. Where the range for the lower limit voltage V1 is −100 mV to 100 mV.

It should be noted that the “delithiation/desodiation capacity at 0.8 V” refers to the delithiation/desodiation capacity of the hard carbon negative electrode material during the constant current charging stage of the coin-type half-cell as the voltage rises to 0.8 V, denoted as A. The ‘delithiation/desodiation capacity at 2 V’ refers to the delithiation/desodiation capacity of the hard carbon negative electrode material at the moment the voltage rises to 2 V during the constant current charging stage of the coin-type half-cell, denoted as B.

(1.2) When testing a three-electrode full battery at 45° C. with charge rates of 0.2 C, 1 C, 2 C, and 3 C, the ratio of lithium/sodium capacity at 50 mV (α1, α2, α3, α4) to the total lithium/sodium capacity of the hard carbon negative electrode material was measured.

In a three-electrode full battery made with hard carbon negative electrode and a reference copper wire electrode, the potential difference between the reference copper wire electrode and the hard carbon negative electrode was the voltage E. During the 3 C charge cycle, when E dropped to 50 mV, the ratio of lithium/sodium intercalation capacity to total lithium/sodium intercalation capacity was α4.

It should be noted that the “lithium/sodium intercalation capacity at 50 mV” and “total lithium/sodium intercalation capacity” occur during the process of the battery being charged at constant current to the upper voltage limit. The “lithium/sodium intercalation capacity at 50 mV” refers to the lithium/sodium intercalation capacity of the hard carbon negative electrode material when the voltage E drops to 50 mV during the constant current charging phase of a three-electrode full battery. The “total lithium/sodium intercalation capacity” refers to the total charging capacity of the three-electrode full battery when the potential difference between the negative electrode and positive electrode reaches the upper limit voltage during the constant current charging phase.

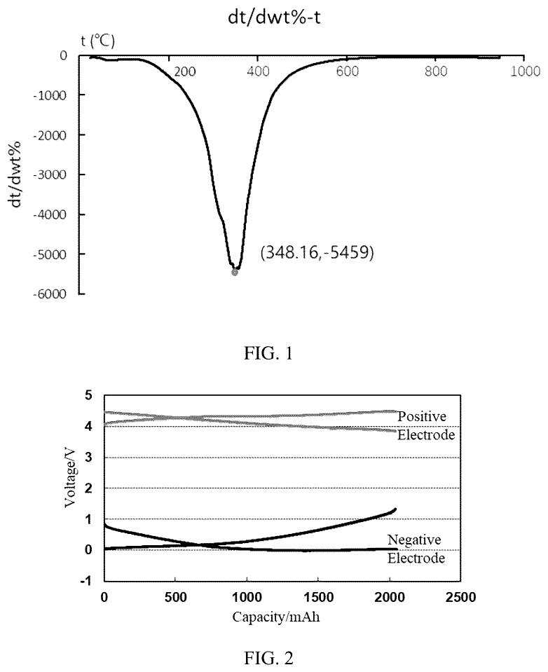

Here, the charge and discharge curves of the three-electrode full battery (lithium-ion battery) in Example 1 at a rate of 3 C at 45° C. were shown in FIG. 2.

(1.3) The ratio C/D of the discharge capacity when the test battery was discharged from 4.45 V to 3 V to the discharge capacity when it was discharged to 2.5 V.

The hard carbon negative electrode was used to create a full battery with a specific positive electrode. The entire battery was discharged at a specific rate current at a voltage of 4.45 V, with the discharge cut-off voltage at 2.5 V The testing software collected test data and analyzed the discharge capacity down to 2.5 V and 3 V Among them, the specific rate current could be 0.1 C, 0.2 C, 0.5 C, 0.7 C, etc., which were recognized by the industry as rates that could discharge normally, with no special restrictions. In this context, the capacity C in “0.1 C” and “0.7 C” etc. referred to the design capacity C marked on the battery itself.

### (2) Testing Capacity Retention Rate

The testing method was as follows.
S1: placing the battery in a 45° C. environment and let it stand for 10 minutes.
S2: charging at a rate of 3 C to 4.45 V, and let it stand for 10 minutes.
S3: discharging at a rate of 0.7 C to 2.5 V, and let it stand for 10 minutes.

The S2-S3 steps were repeated for 800 cycles.

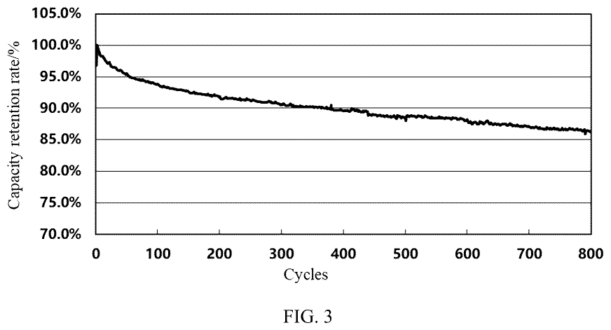

Among them, the capacity C in “3 C rate” and “0.7 C rate” referred to the rated design capacity C marked on the battery itself. Among them, the curve of the capacity retention rate of the battery from example 1 at 3 C rate under 45 C was shown in FIG. 3.

### (3) Test Expansion Rate

The testing method was as follows: the batteries were measured after 800 cycles at room temperature, using a PPG battery thickness tester for measurement.

TABLE 1

| | | | | | | | Capacity retention rate a [symbol] | Expansion rate at |
|---|---|---|---|---|---|---|---|---|
| | A/B | | | | | C/D | 45° C. for 800 T cycles | 45° C. for 800 T cycles |
| Group | Ratio | α1 | α2 | α3 | α4 | ratio | at 3 C rate | at 3 C rate |
| Example 1 | 0.80 | 29% | 48% | 57% | 62% | 0.81 | 86.40% | 4.96% |
| Example 2 | 0.78 | 24% | 46% | 51% | 58% | 0.79 | 85.17% | 6.67% |
| Example 3 | 0.64 | 20% | 39% | 49% | 52% | 0.65 | 82.41% | 7.78% |
| Example 4a | 0.90 | 13% | 28% | 39% | 39% | 0.89 | 76.45% | 9.98% |
| Example 4b | 0.89 | 15% | 26% | 36% | 40% | 0.88 | 80.12% | 9.55% |
| Example 5a | 0.26 | 32% | 52% | 69% | 83% | 0.41 | 75.98% | 8.90% |
| Example 5b | 0.89 | 18% | 31% | 36% | 40% | 0.89 | 79.53% | 9.83% |
| Example 6 | 0.80 | 29% | 48% | 57% | 62% | 0.74 | 93.39% | 4.25% |
| Example 7 | 0.82 | 19% | 39% | 48% | 57% | 0.82 | 83.75% | 6.41% |
| Example 8a | 0.18 | 35% | 57% | 70% | 89% | 0.22 | 66.41% | 10.34% |
| Example 8b | 0.88 | 10% | 23% | 34% | 40% | 0.93 | 72.89% | 13.55% |
| Example 9 | 0.93 | 10% | 29% | 40% | 47% | 0.94 | 85.18% | 9.54% |
| Comparative | 0.93 | 8% | 21% | 32% | 37% | 0.93 | 70.11% | 8.48% |
| example 1 | | | | | | | | |
| Comparative | 0.97 | 7% | 20% | 31% | 35% | 0.98 | 68.40% | 17.55% |
| example 2 | | | | | | | | |
| Comparative | 0.98 | 7% | 22% | 33% | 36% | 0.91 | 88.73% | 12.37% |
| example 3 | | | | | | | | |
| Comparative | 0.17 | 36% | 62% | 77% | 88% | 0.24 | 63.15% | 15.66% |
| example 4 | | | | | | | | |
| Comparative | 0.95 | 6% | 19% | 31% | 32% | 0.95 | 68.07% | 10.34% |
| example 5 | | | | | | | | |
| Comparative | 0.94 | 8% | 23% | 33% | 36% | 0.94 | 69.89% | 10.01% |
| example 6 | | | | | | | | |

[symbol]

indicates data missing or illegible when filed

The results from Table 1, FIG. 2, and FIG. 3 demonstrate that the disclosed hard carbon negative electrode material with the most probable pore size ranging from 0.35 nm to 1.5 nm, and Tmin (dt/dwt %-t) within the range of 150-450° C., exhibits an electrical conductivity of 2-130 S/cm under 63.66 MPa. This material, when combined with sodium metal positive electrodes or cobalt lithium oxide ternary lithium positive electrodes in electrochemical systems, shows C/D ratio values between 0.3 to 0.9. The ratio of lithium/sodium intercalation capacity to total lithium/sodium intercalation capacity (α1, α2, α3, α4) at 50 mV during charging at 0.2 C, 1 C, 2 C, and 3 C rates are within 20%-38%, 30%-55%, 40%-62%, and 42%-78% respectively. This enables a lower negative electrode-positive electrode potential compared to conventional graphite negative electrode materials, effectively enhancing the battery's capacity retention at high temperatures and reducing expansion rates.

The above description is merely optimal examples of the disclosure and should not be construed as limiting the disclosure. Any modifications, equivalent replacements, etc., made within the spirit and principles of the disclosure should be included within the protective scope of the disclosure.

What is claimed is:

1. A hard carbon negative electrode material, comprising a microstructure of multi-microporous layers; wherein a most probable pore size of micropores is 0.35 nm-1.5 nm, and a conductivity of the hard carbon negative electrode material is 0.3-130 S/cm under 63.66 MPa.

2. The hard carbon negative electrode material according to claim 1, wherein the most probable pore size of the micropores is 0.35 nm-1.5 nm, and the conductivity of the hard carbon negative electrode material is 2-130 S/cm under 63.66 MPa.

3. The hard carbon negative electrode material according to claim 1, wherein the most probable pore size of the micropores is 0.4 nm-1.2 nm;
and/or, the electrical conductivity of the hard carbon negative electrode material is 5-80 S/cm at 63.66 Mpa.

4. The hard carbon negative electrode material according to claim 3, wherein the most probable pore size of the micropores is 0.5 nm-0.9 nm.

5. The hard carbon negative electrode material according to claim 1, wherein a temperature range corresponding to a complete removal of water from the micropores of the hard carbon negative electrode material is 150° C.-450° C.;
and/or, an average interlayer spacing d₀₀₂ of layered microstructure is 0.3 nm-0.45 nm;
and/or, a delithiation/desodiation capacity of the hard carbon negative electrode material at 0.8 V is denoted as A, and a delithiation/desodiation capacity at 2 V is denoted as B, with a ratio of A/B being 0.2-0.99.

6. The hard carbon negative electrode material according to claim 5, wherein the temperature range corresponding to the complete removal of water from the micropores of the hard carbon negative electrode material is 160° C.-400° C.;
and/or, the average interlayer distance d₀₀₂ of the layered microstructure is 0.35 nm-0.42 nm;
and/or, the ratio of A/B is 0.2-0.9.

7. The hard carbon negative electrode material according to claim 6, wherein the ratio of A/B is 0.3-0.88.

8. The hard carbon negative electrode material according to claim 1, wherein the hard carbon negative electrode material meets at least one of the following:
(a) a Dv50 of the hard carbon negative electrode material being 0.3 μm-35 μm, and/or; Dv100 not exceeding 100 μm;
(b) a specific surface area of the hard carbon negative electrode material being 0.5 m²/g-80 m²/g; and
(c) a tap density of the hard carbon negative electrode material being 0.2 g/cm³-1.11 g/cm³.

9. The hard carbon negative electrode material according to claim 1, wherein the hard carbon negative electrode material meets at least one of the following requirements:
(i) a Dv50 of the hard carbon negative electrode material being 3 μm-30 μm, and/or; Dv100 not exceeding 90 μm;
(ii) a specific surface area of the hard carbon negative electrode material being 0.8 m²/g-30 m²/g; and
(iii) a tap density of the hard carbon negative electrode material being 0.3 g/cm³−1 g/cm³.

10. The hard carbon negative electrode material according to claim 1, wherein during the evaluation of a three-electrode full battery, when charged at a rate of 0.2 C-3 C, a ratio α of the lithium/sodium intercalation capacity at 50 mV to the total lithium/sodium intercalation capacity of the hard carbon negative electrode material is 12%-85%.

11. The hard carbon negative electrode material according to claim 10, wherein at a charging rate of 0.2 C, a ratio α1 of the lithium/sodium intercalation capacity at 50 mV to the total lithium/sodium intercalation capacity of the hard carbon negative electrode material is 5%-45%;
at a charging rate of 1 C, a ratio α2 of the lithium/sodium intercalation capacity at 50 mV to the total lithium/sodium intercalation capacity of the hard carbon negative electrode material is 25%-60%;
at a charging rate of 2 C, a ratio α3 of the lithium/sodium intercalation capacity at 50 mV to the total lithium/sodium intercalation capacity of the hard carbon negative electrode material is 35%-75%; and
at a charging rate of 3 C, a ratio α4 of the lithium/sodium intercalation capacity at 50 mV to the total lithium/sodium intercalation capacity of the hard carbon negative electrode material is 38%-85%.

12. The hard carbon negative electrode material according to claim 11, wherein at a charging rate of 0.2 C, a ratio α1 of the lithium/sodium intercalation capacity at 50 mV to the total lithium/sodium intercalation capacity of the hard carbon negative electrode material is 10%-38%;
at a charging rate of 1 C, a ratio α2 of the lithium/sodium intercalation capacity at 50 mV to the total lithium/sodium intercalation capacity of the hard carbon negative electrode material is 30%-55%;
at a charging rate of 2 C, a ratio α3 of the lithium/sodium intercalation capacity at 50 mV to the total lithium/sodium intercalation capacity of the hard carbon negative electrode material is 40%-62%; and
at a charging rate of 3 C, a ratio α4 of the lithium/sodium intercalation capacity at 50 mV to the total lithium/sodium intercalation capacity of the hard carbon negative electrode material is 42%-78%.

13. The hard carbon negative electrode material according to claim 1, wherein a precursor of the hard carbon negative electrode material comprises at least one of a resin precursor, an organic polymer pyrolytic carbon precursor, a carbon black precursor, or a biomass carbon precursor.

14. A negative electrode plate, comprising the hard carbon negative electrode material according to claim 1.

15. A battery, comprising the hard carbon negative electrode material according to claim 1.

16. The battery according to claim 15, wherein the battery is a lithium-ion battery, a discharge capacity during a voltage drop from 4.45 V to 3 V is denoted as Cₗᵢₜₕᵢᵤₘ, and a discharge capacity during a voltage drop from 4.45 V to 2.5 V is denoted as Dₗᵢₜₕᵢᵤₘ, with a ratio Cₗᵢₜₕᵢᵤₘ/Dₗᵢₜₕᵢᵤₘ being 0.3-0.9.

17. The battery according to claim 15, wherein the battery is a sodium-ion battery, a discharge capacity during a voltage drop from 4 V to 3 V is denoted as C_{sodium}, and a discharge capacity during a voltage drop from 4 V to 2 V is denoted as D_{sodium}, with a ratio of C_{sodium}/D_{sodium} being 0.5-0.88.

18. A battery, comprising the negative electrode plate according to claim 14.

19. The battery according to claim 18, wherein the battery is a lithium-ion battery, a discharge capacity during a voltage drop from 4.45 V to 3 V is denoted as Cₗᵢₜₕᵢᵤₘ, and a discharge capacity during a voltage drop from 4.45 V to 2.5 V is denoted as Dₗᵢₜₕᵢᵤₘ, with a ratio Cₗᵢₜₕᵢᵤₘ/Dₗᵢₜₕᵢᵤₘ being 0.3-0.9.

20. The battery according to claim 18, wherein the battery is a sodium-ion battery, a discharge capacity during a voltage drop from 4 V to 3 V is denoted as C_{sodium}, and a discharge capacity during a voltage drop from 4 V to 2 V is denoted as D_{sodium}, with a ratio of C_{sodium}/D_{sodium} being 0.5-0.88.
